(19) United States
(12) Patent Application Publication
(10) Pub. No.: US 2026/0321990 A1
(43) Pub. Date: Oct. 15, 2026

(54) ANTENNA DEVICES, ANTENNA ARRAYS AND ANTENNA SYSTEMS

(71) Applicant: HUAWEI TECHNOLOGIES CO., LTD., Shenzhen (CN)

(72) Inventors: Ignacio Gonzalez, Munich (DE); Bruno Biscontini, Munich (DE); Alejandro MURILLO BARRERA, Munich (DE)

(21) Appl. No.: 19/466,742

(22) Filed: Feb. 2, 2026

Related U.S. Application Data
(63) Continuation of application No. PCT/EP2023/071500, filed on Aug. 3, 2023.

(51) Int. Cl. H01Q 21/06; H01Q 9/16; H01Q 19/10

(52) U.S. Cl. CPC H01Q 21/062; H01Q 9/16; H01Q 19/10

(57) ABSTRACT

The present disclosure relates to an antenna device comprising a node for feeding a calibration network, a first radiating element being arranged in a first plane and configured to radiate a radio wave in response to a radio frequency (RF) signal being fed to the first radiating element, a second radiating element being arranged in a second plane that is different to the first plane, and a distribution structure that is configured to feed the RF signal to the first radiating element and the second radiating element by providing an amplitude distribution of the RF signal between the first radiating element and the second radiating element. The distribution structure is configured to feed via the node to the calibration network at least a part of the energy of an electromagnetic coupling between the first radiating element and the second radiating element.

### CROSS-REFERENCE TO RELATED APPLICATIONS

This application is a continuation of International Application No. PCT/EP2023/071500, filed on Aug. 3, 2023, the disclosure of which is hereby incorporated by reference in its entirety.

### TECHNICAL FIELD

The present disclosure relates to antenna devices, antenna arrays and antenna systems, in particular with regard to providing feedback to a calibration network.

### BACKGROUND

With the Long Term Evolution (LTE) rollout already complete and the 5^{th} generation mobile network (5G) rollout ongoing, operators are preparing their networks for the upcoming 5.5 generation mobile network (5.5G). One key technology for enabling this new generation of mobile communications is massive multiple input multiple output (mMIMO) below 6 GHz. Massive multiple input multiple output antenna arrays (mMIMO antenna arrays) may be operated in many different ways, for example using time division duplex (TDD) or frequency division duplex (FDD). All of the different ways of operating a mMIMO antenna array have in common the use of beam forming. Whether the aim is maximizing the directivity of the antenna or generating nulls of interference via zero forcing, phase and amplitude stability play a key role in maximizing the performance of the antenna system.

### SUMMARY

Phase and amplitude deviations generated when manufacturing an antenna array comprising multiple radiating elements for radiating radio waves due to mechanical tolerances may be alleviated by the use of calibration networks. Such type of networks may compensate for amplitude and phase errors generated from the remote radio unit (RRU) to the input of a feeding network for feeding radio frequency (RF) signals to the radiating elements of the antenna array to be transmitted by the radiating elements in the form of radio waves. An input of a feeding network may be referred to as antenna port. The terms “calibration structure” and “feeding structure” may be used as synonyms for the terms “calibration network” and “feeding network”, respectively.

For example, according to the description of a FDD traffic beam, the weights sent by a RRU, e.g. a baseband processing unit of the RRU, to antenna ports, i.e. to ports of a feeding network, are defined in the 3^{rd} generation partnership project (3GPP) specifications. RF signals are transmitted from the RRU to antenna ports (i.e. ports of a feeding network) through RF chains. In an ideal model, the amplitude and phase characteristics and delays of multiple RF channels are pre-defined by the intended radiation pattern. Otherwise, problems such as beam direction deflection, coverage error, and zero depth reduction occur, affecting the beamforming effect in a cell. However, the amplitude and phase characteristics and delays of RF channels cannot be consistent due to factors such as amplitude and phase fluctuation of active components over a long path, the path length of the analog end of each channel, and duplexer group delay difference.

Therefore, signals arriving at the antenna port are calibrated by a calibration network. Antenna calibration, also called channel calibration, aims to ensure the consistency of data delays, amplitudes and phases between channels in a multi-channel system. In principles, the phase, amplitude, and delay of signals change after they are transmitted through different channels. Such changes may be calculated based on changes in the phase, amplitude, and delay of known calibration signals after they are transmitted through different channels. Then, compensation is applied to the channels. In practical scenarios and products, calibration is not done at the antenna level, but before the driving system that may be present. When this is the case, amplitude and phase errors may be accumulated until the radio frequency (RF) signal is radiated. In other words, amplitude and phase errors may also occur from the input of the feeding network to the radiating elements of the antenna array. Such errors may be caused by the antenna array, e.g. by a radome outline, a different environment around the radiating elements (e.g. difference between a radiating element in the center and a radiating element at an edge of the antenna array), different dipoles of the radiating elements, different tuning parts etc. In addition or alternatively, such errors may be caused by the feeding network, e.g. by junctions of the feeding network, driven system error between radiating elements etc.

In view of the above, this disclosure aims to provide an antenna device that allows to reduce amplitude and/or phase errors, which may occur between a feeding network for providing a radio frequency (RF) signals to one or more radiating elements of the antenna device and the one or more radiating elements of the antenna device.

These and other objectives are achieved by the solution of this disclosure as described in the independent claims. Advantageous implementations are further defined in the dependent claims.

A first aspect of this disclosure provides an antenna device. The antenna device comprises a node for feeding a calibration network. The antenna device comprises a first radiating element being arranged in a first plane and configured to radiate a radio wave in response to a radio frequency (RF) signal being fed to the first radiating element. The antenna device comprises a second radiating element being arranged in a second plane that is different to the first plane. The second radiating element is configured to radiate a radio wave in response to the RF signal being fed to the second radiating element. The antenna device comprises a distribution structure that is configured to feed the RF signal to the first radiating element and the second radiating element by providing an amplitude distribution of the RF signal between the first radiating element and the second radiating element. The distribution structure is configured to feed via the node to the calibration network at least a part of the energy of an electromagnetic coupling between the first radiating element and the second radiating element, when the RF signal is fed to the first radiating element and the second radiating element.

In other words, the first aspect proposes to use a dual layer antenna comprising the first radiating element and the second radiating element and provides a calibration path by the distribution structure via the node. This calibration path allows calibrating, e.g. reducing or removing, errors, such as amplitude and/or phase errors, generated from a feeding network for providing the RF signal to the distribution structure in order to be transmitted by the first and second radiating element in the form of radio waves. The first radiating element and the second radiating element may be referred to as dual layer antenna. The term “radio frequency signal (RF signal)” may be abbreviated by the term “radio signal”.

The dual layer antenna allows increasing a directivity of the antenna device with regard to radiating radio waves and, thus, RF signals in the form of radio waves. This allows either a miniaturization of a reflector of the antenna device (may be referred to as antenna reflector) or an increase in coverage and/or an increased signal to interference plus noise ratio (SINR) provided by the antenna device

The term “antenna arrangement” may be used instead of the term “antenna device”. The antenna device may comprise a second node for receiving the radio frequency (RF) signal from a feeding network. The antenna device may comprise the feeding network and the feeding network may be configured to feed the second node. The distribution structure may be configured to receive the RF signal via the second node from the feeding network. The distribution structure may be configured to provide an amplitude distribution of the RF signal between the first radiating element and the second radiating element when the RF signal is received by the second node. The feeding network may be configured to feed the RF signal such that the first and second radiating elements are fed and radiate at the same frequencies. The first radiating element and the second radiating element may be configured to be fed at the same frequencies. The first radiating element and the second radiating element may be configured to radiate at the same frequencies.

The first plane and the second plane may be parallel to each other. The electromagnetic coupling may be referred to as “mutual coupling”. The distribution structure is configured to feed to via the node to the calibration network at least a part of the energy of an electromagnetic coupling between the first radiating element and the second radiating element when the first radiating element and the second radiating element each radiate a radio wave in response to the RF signal being fed to the first radiating element and the second radiating element.

The distribution structure may be configured to feed the RF signal to the first radiating element and the second radiating element such that a first amplitude is fed to the first radiating element and a second amplitude is fed to the second radiating element, wherein the first amplitude and the second amplitude equal to an amplitude of the RF signal. The distribution structure may be configured to control an amplitude difference between the first radiating element and the second radiating element. The amplitude relation between the first radiating element and the second radiating element may be used as a degree of freedom for transmitting the RF signal in the form of radio waves using the first radiating element and the second radiating element. The amplitude distribution between the first radiating element and the second radiating element may be used to improve front to back and cross-polar discrimination of the antenna device.

The distribution structure may be or may comprise a power splitter. The power splitter may be configured such that at least a part of the energy of the electromagnetic coupling between the first radiating element and the second radiating element (when the RF signal is fed to the first radiating element and the second radiating element) dissipated at the power splitter, e.g. at a resistor of the power splitter, is fed via the node to the calibration network. The power splitter may be a Wilkinson splitter. In other words, at least a part of the energy of the electromagnetic coupling between the first radiating element and the second radiating element dissipated at the power splitter may be used as a calibration feedback. Thus, the distribution structure, e.g. power splitter, and the node for feeding the calibration network may be a calibration feedback path for feeding at least a part of the energy of the electromagnetic coupling between the first radiating element and the second radiating element to the calibration network.

The antenna device of the first aspect is described as a transmission (not reception) device. However, it can also be operated as a reception device.

In an implementation form of the first aspect, the distribution structure is configured to provide the RF signal with a phase shift between the first radiating element and the second radiating element when the RF signal is fed to the first radiating element and the second radiating element. Alternatively, the antenna device may comprise a phase shifter arranged between the distribution structure and the first radiating element or the second radiating element. That is, the phase shifter may either be arranged between the distribution structure and the first radiating element or the distribution structure and the second radiating element. The phase shifter may be configured to provide the RF signal with a phase shift between the first radiating element and the second radiating element when the RF signal is fed to the first radiating element and the second radiating element.

The term “phase difference” may be used as a synonym for the term “phase shift”. That is, the distribution structure or the phase shifter may be configured to provide the RF signal with a phase difference between the first radiating element and the second radiating element. The distribution structure or the phase shifter may be configured to control phase difference between the first radiating element and the second radiating element. The phase shift between the first radiating element and the second radiating element may be used to improve front to back and cross-polar discrimination of the antenna device. The phase shifter may be a digital phase shifter or an analog phase shifter.

In an implementation form of the first aspect, the antenna device comprises the calibration network. The calibration network may be configured to use energy, which is fed from the distribution structure via the node to the calibration network, to adjust the amplitude and/or the phase of the RF signal being fed to the first radiating element and the second radiating element.

In other words, the calibration network may be configured to use the energy, which is fed from the distribution structure via the node to the calibration network, to adjust the amplitude and/or the phase of the radio waves radiated by the first radiating element and the second radiating element in response to feeding the RF signal to the first radiating element and the second radiating element.

This allows calibrating, e.g. removing, errors, such as amplitude and/or phase errors, generated from a feeding network for providing the RF signal to the distribution structure in order to be transmitted by the first and second radiating element in the form of radio waves.

In an implementation form of the first aspect, the antenna device comprises a reflector being arranged in a third plane that is different to the first plane and the second plane. The reflector may be configured to reflect the radio waves radiated by the first radiating element and the second radiating element in response to the RF signal being fed to the first radiating element and second radiating element in a main radiating direction.

The first plane may be arranged between the second plane and the third plane. The first plane, the second plane and the third plane may be parallel to each other. The reflector may comprise a planar element arranged in the third plane. For example, the reflector may be a reflector plate arranged in the third plane. The main radiating direction may be the direction away from the reflector.

In an implementation form of the first aspect, the first radiating element, the second radiating element and the reflector are positioned such and the distribution structure is configured such that the radio waves radiated by the first radiating element and the second radiating element interfere constructively in the main radiating direction.

The result may be a combined radiation pattern, which is more directive than the radio wave of a simple/single radiating element. The overall result may be a significant increase in the directivity of the combined radiation pattern of the antenna device. This allows either a miniaturization of the reflector or an increase in coverage and/or an increased signal to interference plus noise ratio (SINR) provided by the antenna device. Thus, the directivity of the antenna device radiation may be improved without sacrificing signal gain.

The distribution structure or the optional phase shifter may be configured to control the phase shift between the first radiating element and the second radiating element such that the radio waves radiated by the first radiating element and the second radiating element interfere constructively in the main radiating direction.

In an implementation form of the first aspect, the first radiating element, the second radiating element and the reflector are arranged on a common axis, and the main radiating direction is the direction away from the reflector along the common axis.

In other words, the first radiating element and second radiating element may be stacked in the normal direction with respect to the reflector.

In an implementation form of the first aspect, the first radiating element and the second radiating element are arranged on a common axis.

The first and second radiating element may be arranged concentrically on the common axis. This may mean that the common axis may run through a center of gravity of each radiating element. The radiating elements of the antenna device may thus be considered collocated.

In an implementation form of the first aspect, the first radiating element and the second radiating element are stacked to each other.

In an implementation form of the first aspect, the first radiating element and the second radiating element each comprise a dipole.

For example, the first radiating element and the second radiating element may each comprise a planar element arranged in its respective plane, e.g. a printed circuit board (PCB) substrate on which a radiating structure, e.g. a dipole, is defined.

The antenna device may be a broadband antenna device and/or may be an antenna device that is suitable for massive multiple input multiple output (mMIMO). The antenna device may be a massive multiple input multiple output antenna device (mMIMO antenna device).

In order to achieve the antenna device according to the first aspect of this disclosure, some or all of the implementation forms and optional features of the first aspect, as described above, may be combined with each other.

A second aspect of this disclosure provides an antenna device. The antenna device comprises a node for feeding a calibration network. The antenna device comprises a first radiating element arranged in a first plane and configured to radiate a radio wave in response to a RF signal being fed to the first radiating element. The antenna device comprises a second radiating element being arranged in a second plane that is different to the first plane. The second radiating element is configured to feed via the node to the calibration network at least a part of the energy of an electromagnetic coupling between the first radiating element and the second radiating element, when the RF signal is fed to the first radiating element.

In other words, the second aspect proposes to use a dual layer antenna comprising the first radiating element and the second radiating element and provides a calibration path by the second radiating element via the node. This calibration path allows calibrating, e.g. reducing or removing, errors, such as amplitude and/or phase errors, generated from a feeding network for providing the RF signal to the first radiating element in order to be transmitted by the first radiating element in the form of radio waves.

The antenna device may comprise a second node for receiving the radio frequency (RF) signal from a feeding network. The antenna device may comprise the feeding network and the feeding network may be configured to feed the second node. The first radiating element may be configured to receive the RF signal via the second node from the feeding network.

The first plane and the second plane may be parallel to each other. The electromagnetic coupling may be referred to as “mutual coupling”. The second radiating element is configured to feed to the node at least a part of the energy of an electromagnetic coupling between the first radiating element and the second radiating element when the first radiating element radiates a radio wave in response to the RF signal being fed to the first radiating element.

The antenna device of the second aspect is described as a transmission (not reception) device. However, it can also be operated as a reception device

In an implementation form of the second aspect, the antenna device comprises the calibration network; and the calibration network is configured to use energy, which is fed from the second radiating element via the node to the calibration network, to adjust the amplitude and/or the phase of the RF signal being fed to the first radiating element.

The calibration network may be configured to use the energy, which is fed from the second radiating element via the node to the calibration network, to adjust the amplitude and/or the phase of the radio wave radiated by the first radiating element in response to feeding the RF signal to the first radiating element.

This allows calibrating, e.g. removing, errors, such as amplitude and/or phase errors, generated from a feeding network for providing the RF signal to the first radiating element in order to be transmitted by the first radiating element in the form of radio waves.

In an implementation form of the second aspect, the antenna device comprises a reflector arranged in a third plane that is different to the first plane and second plane. The reflector may be configured to reflect the radio wave radiated by the first radiating element in response to the RF signal being fed to the first radiating element in a main radiating direction.

The first plane may be arranged between the second plane and the third plane. The first plane, the second plane and the third plane may be parallel to each other. The reflector may comprise a planar element arranged in the third plane. For example, the reflector may be a reflector plate arranged in the third plane. The main radiating direction may be the direction away from the reflector.

In an implementation form of the second aspect, the first radiating element, the second radiating element and the reflector are arranged on a common axis, and the main radiating direction is the direction away from the reflector along the common axis.

In other words, the first radiating element and second radiating element may be stacked in the normal direction with respect to the reflector.

In an implementation form of the second aspect, the first radiating element and the second radiating element are arranged on a common axis.

The first and second radiating element may be arranged concentrically on the common axis. This may mean that the common axis may run through a center of gravity of each radiating element. The radiating elements of the antenna device may thus be considered collocated.

In an implementation form of the second aspect, the first radiating element and the second radiating element are stacked to each other.

In an implementation form of the second aspect, the first radiating element and the second radiating element each comprise a dipole.

For example, the first radiating element and the second radiating element may each comprise a planar element arranged in its respective plane, e.g. a printed circuit board (PCB) substrate on which a radiating structure, e.g. a dipole, is defined.

The antenna device may be a broadband antenna device and/or may be an antenna device that is suitable for massive multiple input multiple output (mMIMO). The antenna device may be a massive multiple input multiple output antenna device (mMIMO antenna device).

The above description of the antenna device according to the first aspect is correspondingly valid for the antenna device according to the second aspect. The above description of the antenna device according to the second aspect is correspondingly valid for the antenna device according to the first aspect.

The antenna device of the second aspect and its implementation forms and optional features achieve the same advantages as the antenna device of the first aspect and its respective implementation forms and respective optional features.

In order to achieve the antenna device according to the second aspect of this disclosure, some or all of the implementation forms and optional features of the second aspect, as described above, may be combined with each other.

A third aspect of this disclosure provides an antenna array that comprises two or more antenna devices according to the first aspect of this disclosure or two or more antenna devices according to the second aspect of this disclosure.

The antenna array may be a broadband antenna array and/or may be an antenna array that is suitable for massive multiple input multiple output (mMIMO). The antenna array may be a massive multiple input multiple output antenna array (mMIMO antenna array).

The above description of the antenna device according to the first aspect is correspondingly valid for the antenna array according to the third aspect. The above description of the antenna device according to the second aspect is correspondingly valid for the antenna array according to the third aspect.

The antenna array of the third aspect and its implementation forms and optional features achieve the same advantages as the antenna device of the first aspect and its respective implementation forms and respective optional features.

A fourth aspect of this disclosure provides an antenna array comprising one or more antenna devices according to the first aspect of this disclosure and one or more antenna devices according to the second aspect of this disclosure.

The antenna array may be a broadband antenna array and/or may be an antenna array that is suitable for massive multiple input multiple output (mMIMO). The antenna array may be a massive multiple input multiple output antenna array (mMIMO antenna array).

The above description of the antenna device according to the first aspect is correspondingly valid for the antenna array according to the fourth aspect. The above description of the antenna device according to the second aspect is correspondingly valid for the antenna array according to the fourth aspect.

The antenna array of the fourth aspect and its implementation forms and optional features achieve the same advantages as the antenna device of the first aspect and its respective implementation forms and respective optional features.

A fifth aspect of this disclosure provides an antenna system comprising one or more antenna devices according to the first aspect of this disclosure, and a calibration network configured to be fed from the node of each of the one or more antenna devices.

The calibration network may be configured to use energy, which is fed from the distribution structure of the respective antenna device via the node of the respective antenna device to the calibration network, to adjust the amplitude and/or the phase of the RF signal being fed to the first radiating element and the second radiating element of the respective antenna device.

Each of the one or more antenna devices may comprise a second node for receiving a radio frequency (RF) signal. The antenna system may comprise a feeding network and the feeding network may be configured to feed the second node of each of the one or more antenna devices. The distribution structure of each of the one or more antenna devices may be configured to receive a RF signal via the second node of the respective antenna device from the feeding network.

Optionally, the antenna system comprises one or more antenna devices according to the second aspect of this disclosure, wherein the calibration network is configured to be fed from the node of each of the one or more antenna devices according to the second aspect. The calibration network may be configured to use the energy, which is fed from the second radiating element of the respective antenna device of the second aspect via the node of the respective antenna device of the second aspect to the calibration network, to adjust the amplitude and/or the phase of the RF signal being fed to the first radiating element of the respective antenna device of the second aspect. Each of the one or more antenna devices of the second aspect may comprise a second node for receiving the radio frequency (RF) signal. The feeding network may be configured to feed the second node of each of the one or more antenna devices of the second aspect. The first radiating element of each of the one or more antenna devices of the second aspect may be configured to receive a RF signal via the second node of the respective antenna device of the second aspect from the feeding network.

The above description of the antenna device according to the first aspect is correspondingly valid for the antenna system according to the fifth aspect. The above description of the antenna device according to the second aspect may be correspondingly valid for the antenna system according to the fifth aspect.

The antenna system of the fifth aspect and its implementation forms and optional features achieve the same advantages as the antenna device of the first aspect and its respective implementation forms and respective optional features.

In order to achieve the antenna system according to the fifth aspect of this disclosure, some or all of the implementation forms and optional features of the fifth aspect, as described above, may be combined with each other.

A sixth aspect of this disclosure provides an antenna system comprising one or more antenna devices according to the second aspect of this disclosure, and a calibration network configured to be fed from the node of each of the one or more antenna devices.

The calibration network may be configured to use energy, which is fed from the second radiating element of the respective antenna device via the node of the respective antenna device to the calibration network, to adjust the amplitude and/or the phase of the RF signal being fed to the first radiating element of the respective antenna device.

Each of the one or more antenna devices may comprise a second node for receiving the radio frequency (RF) signal. The antenna system may comprise a feeding network and the feeding network may be configured to feed the second node of each of the one or more antenna devices. The first radiating element of each of the one or more antenna devices may be configured to receive the RF signal via the second node of the respective antenna device from the feeding network.

Optionally, the antenna system comprises one or more antenna devices according to the first aspect of this disclosure, wherein the calibration network is configured to be fed from the node of each of the one or more antenna devices according to the first aspect. The calibration network may be configured to use the energy, which is fed from the distribution structure of the respective antenna device of the first aspect via the node of the respective antenna device of the first aspect to the calibration network, to adjust the amplitude and/or the phase of the RF signal being fed to the first radiating element and the second radiating element of the respective antenna device of the first aspect. Each of the one or more antenna devices of the first aspect may comprise a second node for receiving a radio frequency (RF) signal. The feeding network may be configured to feed the second node of each of the one or more antenna devices of the first aspect. The distribution structure of each of the one or more antenna devices of the first aspect may be configured to receive a RF signal via the second node of the respective antenna device of the first aspect from the feeding network.

The above description of the antenna device according to the second aspect is correspondingly valid for the antenna system according to the sixth aspect. The above description of the antenna device according to the first aspect may be correspondingly valid for the antenna system according to the sixth aspect.

The antenna system of the sixth aspect and its implementation forms and optional features achieve the same advantages as the antenna device of the second aspect and its respective implementation forms and respective optional features.

In order to achieve the antenna system according to the sixth aspect of this disclosure, some or all of the implementation forms and optional features of the sixth aspect, as described above, may be combined with each other.

It has to be noted that all devices, elements, units and means described in the present application could be implemented in software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which

FIG. 1 shows an example of an antenna device according to this disclosure;

FIG. 2 shows an example of an antenna device according to this disclosure;

FIG. 3 shows a block diagram of an example of an antenna device according to this disclosure and a block diagram of an example of a distribution structure of the antenna device;

FIG. 4 shows an example of an antenna device according to this disclosure;

FIG. 5 shows an example of an antenna array according to this disclosure;

FIG. 6 shows an example of an antenna array according to this disclosure;

FIG. 7 shows an example of an antenna array according to this disclosure;

FIG. 8 shows an example of an antenna system according to this disclosure; and

FIG. 9 shows an example of an antenna system according to this disclosure.

Same elements shown in the Figures are labeled with the same reference sign, and may be implemented likewise.

### DETAILED DESCRIPTION OF EMBODIMENTS

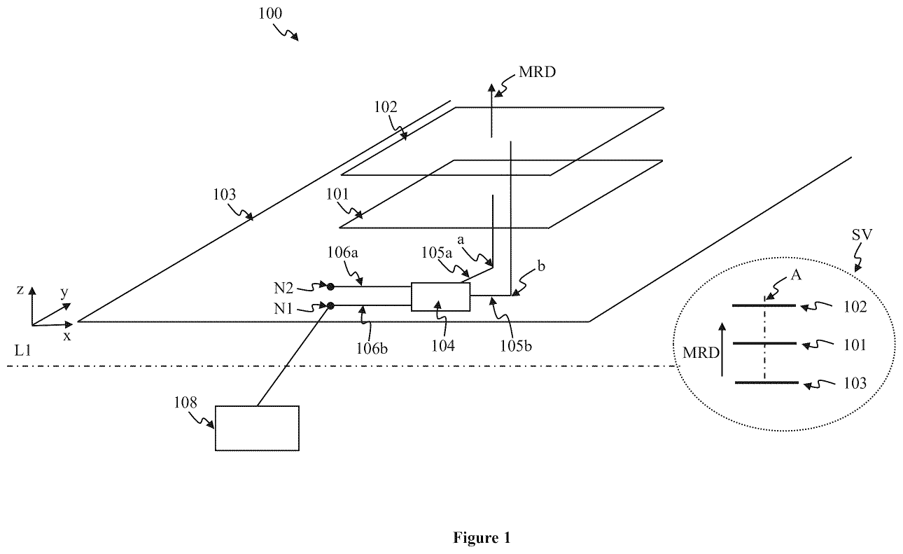

FIG. 1 shows an example of an antenna device according to this disclosure. The antenna device 100 of FIG. 1 is an example of the antenna device according to the first aspect of this disclosure. The description of the antenna device according to the first aspect is correspondingly valid for the antenna device 100 of FIG. 1.

The antenna device 100 of FIG. 1 may be a broadband antenna device and/or may be an antenna device that is suitable for massive multiple input multiple output (mMIMO). As shown in FIG. 1, the antenna device 100 comprises a node N1 for feeding a calibration network 108. The antenna device 100 comprises a first radiating element 101 being arranged in a first plane and configured to radiate a radio wave in response to a radio frequency (RF) signal being fed to the first radiating element 101. The antenna device 100 comprises a second radiating element 102 being arranged in a second plane that is different to the first plane. The second radiating element 102 is configured to radiate a radio wave in response to the RF signal being fed to the second radiating element 102. The antenna device 100 comprises a distribution structure 104 that is configured to feed the RF signal to the first radiating element 101 and the second radiating element 102 by providing an amplitude distribution of the RF signal between the first radiating element 101 and the second radiating element 102. The distribution structure 104 is configured to feed via the node N1 to the calibration network 108 at least a part of the energy of an electromagnetic coupling between the first radiating element 101 and the second radiating element 102, when the RF signal is fed to the first radiating element 101 and the second radiating element 102.

As indicated in FIG. 1, the distribution structure 104 may feed the RF signal with the respective amplitude to the first radiating element 101 via a feed line 105a and to the second radiating element 102 via a feed line 105b. The distribution structure 104 may feed to the node N1 and, thus, via the node N1 to the calibration network 108 at least a part of the energy of the electromagnetic coupling between the first radiating element 101 and the second radiating element 102 via a feed line 106b. The distribution structure 104 may split power of the RF signal between the first radiating element 101 and the second radiating element 102. The power relationship, i.e. amplitude relation or amplitude distribution, between the first radiating element 101 and the second radiating element 102 may depend on an amount of increase in directivity.

In FIG. 1, the dashed line L1 indicates a border between elements that are part of the antenna device 100 and that are not part of the antenna device 100, i.e. they are external elements. According to FIG. 1, it is assumed that the calibration network 108 is an external element with regard to the antenna device 100 that may be coupled, e.g. electrically connected, to the antenna device 100, e.g. to a port of the antenna device 100, in order to receive energy being fed from the distribution structure 104 to the node N1. Optionally, the antenna device 100 may comprise the calibration network 108. The calibration network 108 may be part of the antenna device 100. The calibration network 108 may be configured to use energy, which is fed from the distribution structure 104 via the node N1 to the calibration network 108, to adjust the amplitude and/or the phase of the RF signal being fed to the first radiating element 101 and the second radiating element 102.

As shown in FIG. 1, the antenna device 100 may comprise a second node N2 for receiving the radio frequency (RF) signal from a feeding network (not shown in FIG. 1). The feeding network may be an external element with regard to the antenna device 100 that may be coupled, e.g. electrically connected, to the antenna device 100, e.g. to a port of the antenna device 100, in order to feed the RF signal to the second node N2 and, thus, via the second node N2 to the distribution structure 104. Optionally, the antenna device 100 may comprise the feeding network and the feeding network may be configured to feed the second node N2. The distribution structure 104 may be configured to receive the RF signal via the second node N2 from the feeding network. The distribution structure 104 may be configured to provide an amplitude distribution of the RF signal between the first radiating element 101 and the second radiating element 102 when the RF signal is received by the second node N2. As shown in FIG. 1, the distribution structure 104 may receive the RF signal from the second node N2 via a feed line 106a.

A feeding point of the first radiating element 101 being fed from the distribution structure 104 via the feed line 105a is indicated by the reference sign “a”. A feeding point of the second radiating element 102 being fed from the distribution structure 104 via the feed line 105b is indicated by the reference sign “b”. The distribution structure 104 may be configured to provide a balance with regard to the feeding point a and the feeding point b. This allows a broadband transmission by the first radiating element 101 and the second radiating element 102. A coupling between the points a and b may be minimized to maximize a radiation efficiency.

As shown in FIG. 1, the antenna device 100 may comprise a reflector 103 (may be referred to as antenna reflector) being arranged in a third plane that is different to the first plane and the second plane. The reflector 103 may be configured to reflect the radio waves radiated by the first radiating element 101 and the second radiating element 102 in response to the RF signal being fed to the first radiating element 101 and second radiating element 102 in a main radiating direction MRD. As indicated in FIG. 1, the main radiating direction MRD may be the normal direction away from the reflector 103. The normal direction corresponds to the direction of the z-axis of the coordinate system shown FIG. 1. As shown in FIG. 1, the first, second and third plane each extend in the direction of the y-axis and direction of the x-axis. Thus, the first radiating element 101, second radiating element 102 and the reflector 103 extend in the direction of the y-axis and direction of the x-axis.

As shown in FIG. 1, the first radiating element 101 and the second radiating element 102 may each comprise a planar element arranged in its respective plane. For example, the first radiating element 101 and the second radiating element 102 may each comprise a printed circuit board (PCB) substrate on which a radiating structure, e.g. a dipole, is defined, wherein the PCB substrate is arranged in the first plane (in case of the first radiating element 101) or the second plane (in case of the second radiating element 102), respectively. The first radiating element 101 and the second radiating element 102 may be configured such that they provide a similar impedance for the distribution structure 104.

The reflector 103 may comprise a planar element arranged in the third plane. For example, the reflector 103 may be a reflector plate arranged in the third plane.

At the bottom right of FIG. 1 a schematic side view of the antenna device is shown in a circle SV. According thereto, the first radiating element 101, the second radiating element 102 and the reflector 103 may be arranged on a common axis A. The main radiating direction MRD is the direction away from the reflector 103 along the common axis A. The first and second radiating element 101, 102 may be arranged concentrically on the common axis A. This may mean that the common axis A may run through a center of gravity of each radiating element 101, 102. The radiating elements 101, 102 of the antenna device 100 may thus be considered collocated.

The first radiating element 101 and the second radiating element 102 may be stacked to each other. In particular, they may be stacked in the normal direction with respect to the reflector 103.

For further details on the antenna device 100 of FIG. 1 reference is made to the description of the antenna device according to the first aspect of this disclosure.

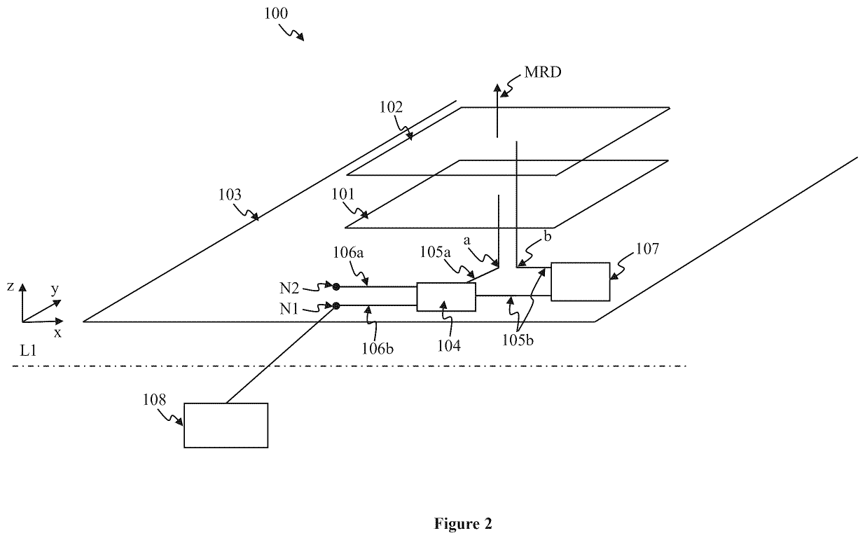

FIG. 2 shows an example of an antenna device according to this disclosure. The antenna device 100 of FIG. 2 is an example of an optional implementation form of the antenna device 100 of FIG. 1. In the following, mainly an optional feature of the antenna device 100 of FIG. 2 is described and otherwise reference is made to the description of the antenna device 100 of FIG. 1.

As shown in FIG. 2, the antenna device 100 may comprise a phase shifter 107 arranged between the distribution structure 104 and the second radiating element 102. That is, the phase shifter 107 may be arranged in the feed line 105b for feeding the RF signal with the respective amplitude from the distribution structure 104 to the second radiating element 102. Alternatively, the phase shifter 107 may be arranged between the distribution structure 104 and the first radiating element 101 (not shown in FIG. 2). That is, the phase shifter 107 may be arranged in the feed line 105a for feeding the RF signal with the respective amplitude from the distribution structure 104 to the first radiating element 101 (not shown in FIG. 2). The phase shifter 107 is configured to provide the RF signal with a phase shift between the first radiating element 101 and the second radiating element 102 when the RF signal is fed to the first radiating element 101 and the second radiating element 102.

In an alternative implementation form, the distribution structure 104 may be configured to provide the RF signal with a phase shift between the first radiating element 101 and the second radiating element 102 when the RF signal is fed to the first radiating element 101 and the second radiating element 102. That is, in the aforementioned optional implementation form, the distribution structure 104 may provide the RF signal to the first radiating element 101 and the second radiating element 102 such that there is an amplitude distribution of the RF signal between the first radiating element 101 and the second radiating element 102 and there is a phase difference of the RF signal between the first radiating element 101 and the second radiating element 102. In the aforementioned case, the antenna device 100 may not comprise the phase shifter 107.

The calibration network 108 may be configured to use the energy, which is fed from the distribution structure 104 via the node N1 to the calibration network 108, to adjust the amplitude and/or the phase of the RF signal being fed to the first radiating element 101 and the second radiating element 102. The phase relationship, i.e. phase difference, between the first radiating element 101 and the second radiating element 102 may depend on an amount of increase in directivity.

For further details on the antenna device 100 of FIG. 2 reference is made to the description of the antenna device 100 of FIG. 1 and the description of the antenna device according to the first aspect of this disclosure.

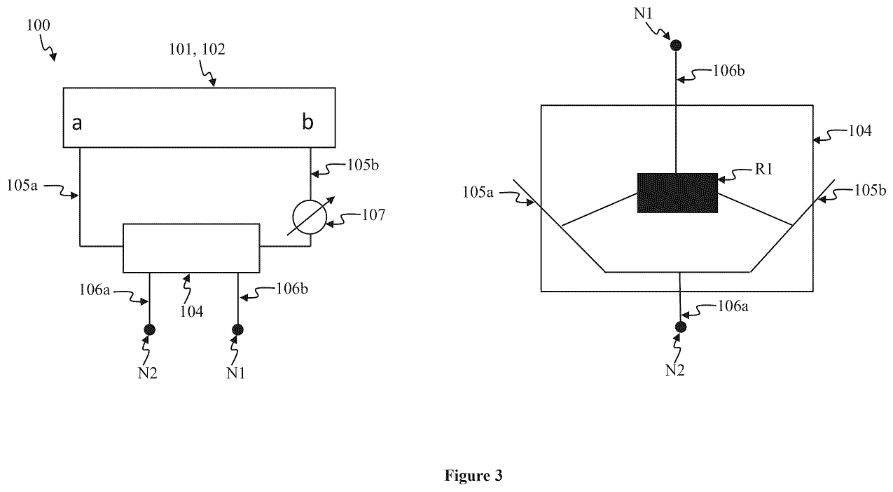

FIG. 3 shows a block diagram of an example of an antenna device according to this disclosure and a block diagram of an example of a distribution structure of the antenna device. The antenna device 100 of FIG. 3 is the antenna device 100 of FIG. 2 and, thus, the description of FIGS. 1 and 2 are correspondingly valid for the antenna device 100 of FIG. 3.

With regard to the antenna device 100 of FIG. 3, the phase shifter 107 is merely optional and, thus, the following description is valid irrespective of whether the phase shifter 107 is present or not and irrespective of whether the distribution structure 104 is configured to provide the RF signal with a phase shift between the first radiating element 101 and the second radiating element 102. Thus, the description of FIG. 3 is also valid for the antenna device of FIG. 1. On the left of FIG. 3, the first radiating element 101 and the second radiating element 102 are shown as a block representing a dual layer antenna that may be formed by the first radiating element 101 and the second radiating element 102.

On the right side of FIG. 3, an example of an implementation form of the distribution structure 104 is shown. According to the shown example, the distribution structure 104 is a Wilkinson splitter. The distribution structure 104 is not limited thereto and, thus, may be or may comprise any other known power splitter. As shown in FIG. 3, the power splitter 104 may be configured such that at least a part of the energy of the electromagnetic coupling between the first radiating element 101 and the second radiating element 102 (when the RF signal is fed to the first radiating element 101 and the second radiating element 102) dissipated at the power splitter 104, e.g. at a resistor R1 of the power splitter 104, may be fed via the node N1 to the calibration network 108. The power splitter 104 may be configured to provide a balance with regard to the feeding point a and the feeding point b. The first radiating element 101 and the second radiating element 102 may be configured such that they provide a similar impedance for the power splitter 104. In case the beam splitter 104 is a Wilkinson splitter, the resistor R1 may be referred to as Wilkinson resistor R1.

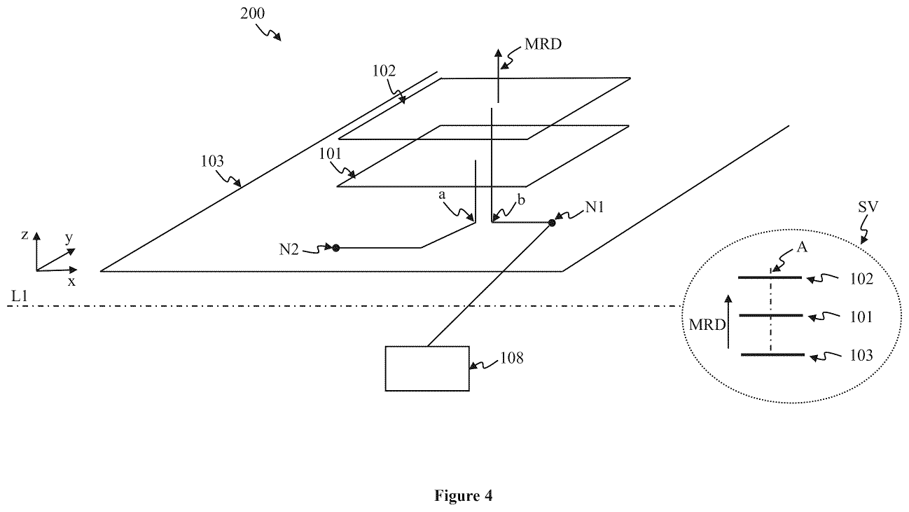

FIG. 4 shows an example of an antenna device according to this disclosure. The antenna device 200 of FIG. 4 is an example of the antenna device according to the second aspect of this disclosure. The description of the antenna device according to the second aspect is correspondingly valid for the antenna device 200 of FIG. 4.

The antenna device 200 of FIG. 4 may be a broadband antenna device and/or may be an antenna device that is suitable for massive multiple input multiple output (mMIMO). As shown in FIG. 4, the antenna device 200 comprises a node N1 for feeding a calibration network 108. The antenna device 200 comprises a first radiating element 101 arranged in a first plane and configured to radiate a radio wave in response to a RF signal being fed to the first radiating element 101. The antenna device 200 comprises a second radiating element 102 being arranged in a second plane that is different to the first plane. The second radiating element 102 is configured to feed via the node N1 to the calibration network 108 at least a part of the energy of an electromagnetic coupling between the first radiating element 101 and the second radiating element 102, when the RF signal is fed to the first radiating element 101.

In FIG. 4, the dashed line L1 indicates a border between elements that are part of the antenna device 200 and that are not part of the antenna device 200, i.e. they are external elements. According to FIG. 4, it is assumed that the calibration network 108 is an external element with regard to the antenna device 200 that may be coupled, e.g. electrically connected, to the antenna device 200, e.g. to a port of the antenna device 200, in order to receive energy being fed from the second radiating element 102 to the node N1. Optionally, the antenna device 200 may comprise the calibration network 108. The calibration network 108 may be part of the antenna device 200. The calibration network 108 may be configured to use energy, which is fed from the second radiating element 102 via the node N1 to the calibration network 108, to adjust the amplitude and/or the phase of the RF signal being fed to the first radiating element 101.

As shown in FIG. 4, the antenna device 200 may comprise a second node N2 for receiving the radio frequency (RF) signal from a feeding network (not shown in FIG. 4). The feeding network may be an external element with regard to the antenna device 200 that may be coupled, e.g. electrically connected, to the antenna device 200, e.g. to a port of the antenna device 200, in order to feed the RF signal to the second node N2 and, thus, via the second node N2 to the first radiating element 101. Optionally, the antenna device may comprise the feeding network and the feeding network may be configured to feed the second node N2. The first radiating element 101 may be configured to receive the RF signal via the second node N2 from the feeding network.

A feeding point of the first radiating element 101 being fed from the second node N2 is indicated ted by the reference sign “a”. A feeding point of the second radiating element 102 for feeding the node N1 is indicated by the reference sign “b”. A coupling between the points a and b may be minimized to maximize a radiation efficiency. The second radiating element 102 may be designed such that it has a minimal impact into an impedance of the first radiating element 101. The second radiating element 102 may be inefficient as a radiator and detuned at the operation frequency of the first radiating element 101, which is used for radiating radio waves. Namely, it is sufficient that the second radiating element 102 is configured to absorb a small quantity of radio waves radiated by the first radiating element 101.

As shown in FIG. 4, the antenna device 200 may comprise a reflector 103 (may be referred to as antenna reflector) being arranged in a third plane that is different to the first plane and the second plane. The reflector 103 may be configured to reflect the radio waves radiated by the first radiating element 101 in response to the RF signal being fed to the first radiating element 101 in a main radiating direction MRD. As indicated in FIG. 4, the main radiating direction MRD may be the normal direction away from the reflector 103. The normal direction corresponds to the direction of the z-axis of the coordinate system shown FIG. 4. As shown in FIG. 4, the first, second and third plane each extend in the direction of the y-axis and direction of the x-axis. Thus, the first radiating element 101, second radiating element 102 and the reflector 103 extend in the direction of the y-axis and direction of the x-axis.

As shown in FIG. 4, the first radiating element 101 and the second radiating element 102 may each comprise a planar element arranged in its respective plane. For example, the first radiating element 101 and the second radiating element 102 may comprise a printed circuit board (PCB) substrate on which a radiating structure, e.g. a dipole, is defined, wherein the PCB substrate is arranged in the first plane (in case of the first radiating element 101) or the second plane (in case of the second radiating element 102), respectively.

The reflector 103 may comprise a planar element arranged in the third plane. For example, the reflector 103 may be a reflector plate arranged in the third plane.

At the bottom right of FIG. 4 a schematic side view of the antenna device 200 is shown in a circle SV. According thereto, the first radiating element 101, the second radiating element 102 and the reflector 103 may be arranged on a common axis A. The main radiating direction MRD is the direction away from the reflector 103 along the common axis A. The first and second radiating element 101, 102 may be arranged concentrically on the common axis A. This may mean that the common axis A may run through a center of gravity of each radiating element 101, 102. The radiating elements 101, 102 of the antenna device 200 may thus be considered collocated.

The first radiating element 101 and the second radiating element 102 may be stacked to each other. In particular, they may be stacked in the normal direction with respect to the reflector 103.

For further details on the antenna device 200 of FIG. 4 reference is made to the description of the antenna device according to the second aspect of this disclosure. The description of the antenna device of FIG. 1 is correspondingly valid for the antenna device of FIG. 4. For example, the description of the arrangement and implementation of the first radiating element, second radiating element and the reflector of the antenna device of FIG. 1 is valid for the first radiating element, second radiating element and reflector of the antenna device of FIG. 4.

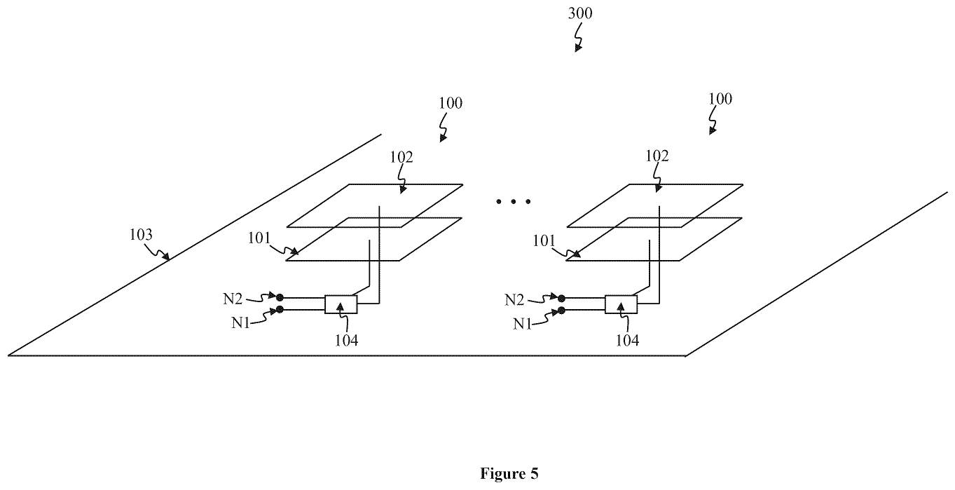

FIG. 5 shows an example of an antenna array according to this disclosure. The antenna array 300 of FIG. 5 is an example of the antenna array according to the third aspect of this disclosure. The description of the antenna array according to the third aspect is correspondingly valid for the antenna array 300 of FIG. 5.

As shown in FIG. 5, the antenna array 300 comprises two or more antenna devices 100 of FIG. 1. For a description of the two or more antenna devices 100 reference is made to the description of the antenna device 100 of FIG. 1. At least one, optional each, of the two or more antenna devices 100 may be implemented according to the description of FIGS. 2 and 3. Instead of each antenna device 100 comprising its own reflector, the antenna array 300 may comprise a common reflector 103 for all two or more antenna devices 100 of the antenna array 300. The description of a reflector of an antenna device herein is correspondingly valid for the common reflector 103. Alternatively, the antenna devices 100 may each comprise a respective reflector 103 and the reflectors 103 of the two or more antenna devices 100 may form a reflector of the antenna array 300.

For further details on the antenna array of FIG. 5 reference is made to the description of the antenna array according to the third aspect of this disclosure and to the description of FIGS. 1 to 3.

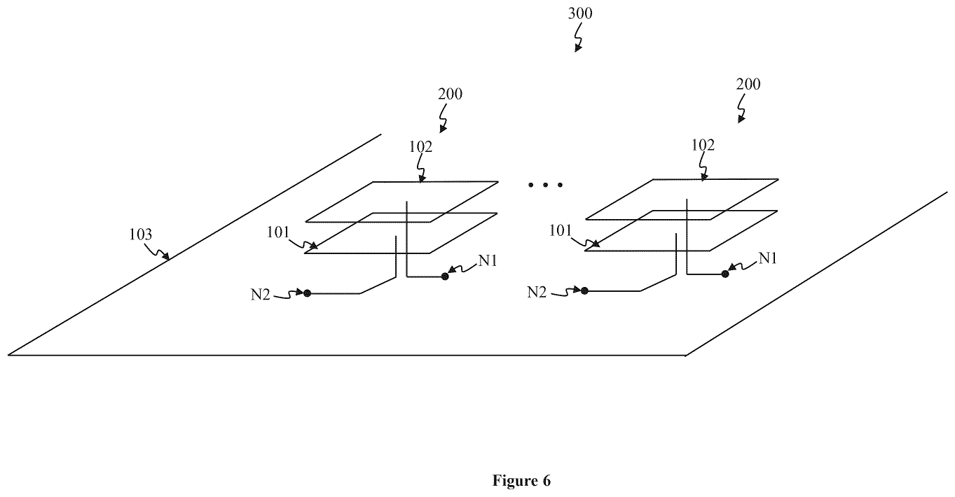

FIG. 6 shows an example of an antenna array according to this disclosure. The antenna array 300 of FIG. 6 is an example of the antenna array according to the third aspect of this disclosure. The description of the antenna array according to the third aspect is correspondingly valid for the antenna array 300 of FIG. 6.

As shown in FIG. 6, the antenna array 300 comprises two or more antenna devices 200 of FIG. 4. For a description of the two or more antenna devices 200 reference is made to the description of the antenna device 200 of FIG. 4. Instead of each antenna device 200 comprising its own reflector, the antenna array 300 may comprise a common reflector 103 for all two or more antenna devices 200 of the antenna array 300. The description of a reflector of an antenna device herein is correspondingly valid for the common reflector 103. Alternatively, the antenna devices 200 may each comprise a respective reflector 103 and the reflectors 103 of the two or more antenna devices 200 may form a reflector of the antenna array 300.

For further details on the antenna array of FIG. 6 reference is made to the description of the antenna array according to the third aspect of this disclosure and to the description of FIG. 4.

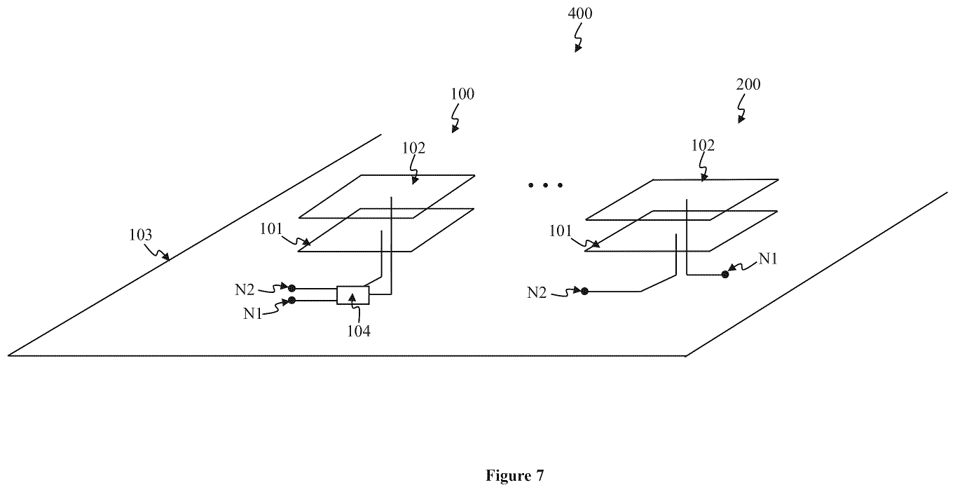

FIG. 7 shows an example of an antenna array according to this disclosure. The antenna array 400 of FIG. 7 is an example of the antenna array according to the fourth aspect of this disclosure. The description of the antenna array according to the fourth aspect is correspondingly valid for the antenna array 400 of FIG. 7.

According to the example of FIG. 7, the antenna array 400 comprises one or more antenna devices 100 of FIG. 1, and one or more antenna devices 200 of FIG. 4. For a description of the one or more antenna devices 100 reference is made to the description of the antenna device 100 of FIG. 1. At least one, optional each, of the one or more antenna devices 100 may be implemented according to the description of FIGS. 2 and 3. For a description of the one or more antenna devices 200 reference is made to the description of the antenna device 200 of FIG. 4. Instead of each antenna device 100, 200 comprising its own reflector, the antenna array 400 may comprise a common reflector 103 for all antenna devices 100, 200 of the antenna array 400. The description of a reflector of an antenna device herein is correspondingly valid for the common reflector 103. Alternatively, the antenna devices 100, 200 may each comprise a respective reflector 103 and the reflectors 103 of the antenna devices 100, 200 may form a reflector of the antenna array 400.

For further details on the antenna array of FIG. 7 reference is made to the description of the antenna array according to the fourth aspect of this disclosure and to the description of FIGS. 1 to 4.

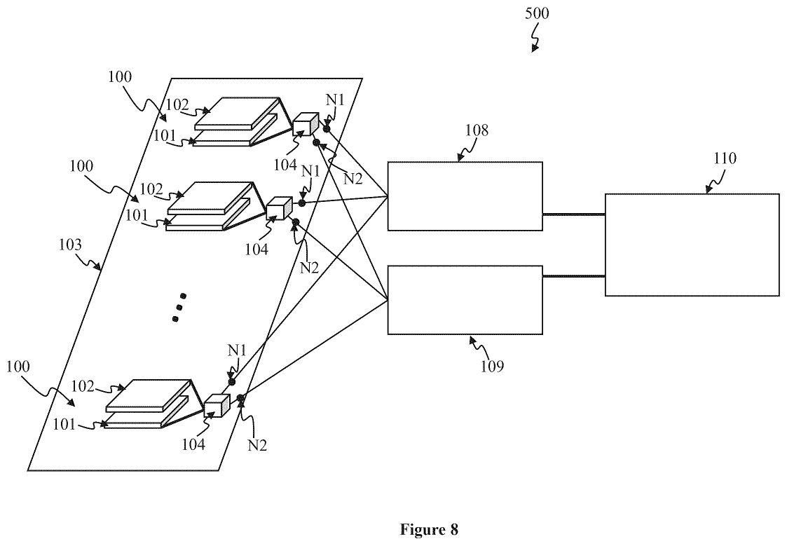

FIG. 8 shows an example of an antenna system according to this disclosure. The antenna system 500 of FIG. 8 is an example of the antenna system according to the fifth aspect of this disclosure. The description of the antenna system according to the fifth aspect is correspondingly valid for the antenna system 500 of FIG. 8.

According to the example of FIG. 8, the antenna system 500 comprises three antenna devices 100 of FIG. 1. The number of antenna devices shown in FIG. 8 is only by way of example and, thus, the antenna system 500 may comprise one or more antenna devices 100 of FIG. 1. The following description is valid irrespective of the number of antenna devices of the antenna system 500. For a description of the one or more antenna devices 100 reference is made to the description of the antenna device of FIG. 1. At least one, optional each, of the one or more antenna devices 100 may be implemented according to the description of FIGS. 2 and 3. Instead of each antenna device 100 comprising its own reflector, the antenna system 500 may comprise a common reflector 103 for all one or more antenna devices 100 of the antenna system 500. The description of a reflector of an antenna device herein is correspondingly valid for the common reflector 103. Alternatively, the one or more antenna devices 100 may each comprise a respective reflector 103 and the reflector(s) 103 of the one or more antenna devices 100 may form a reflector of the antenna system 500. In case the antenna system comprises two or more antenna devices 100, the antenna devices 100 may form an antenna array according to FIG. 5.

The antenna system 500 may comprise a calibration network 108 configured to be fed from the node N1 of each of the one or more antenna devices 100. The calibration network 108 may be configured to use the energy, which is fed from the distribution structure 104 of the respective antenna device 100 via the node N1 of the respective antenna device 100 to the calibration network 108, to adjust the amplitude and/or the phase of the RF signal being fed to the first radiating element 101 and the second radiating element 102 of the respective antenna device 100.

Optionally, the antenna system 500 may comprise a feeding network 109 configured to feed a respective RF signal to the second node N2 of each antenna device 100 to transmit the respective RF signal in the form of radio waves. Thus, the feeding network 109 is configured to feed a RF signal via the second node N2 of each antenna device 100 to the distribution structure 104 of the respective antenna device 100. The antenna system 500 may optionally comprise a remote radio unit (RRU) 110 coupled, e.g. electrically connected, to the calibration network 108 and the feeding network 109. The RRU 110 may be configured to control the calibration network 108 and the feeding network 109. The RRU 110 may comprise or may be coupled, e.g. electrically connected, to a base band unit.

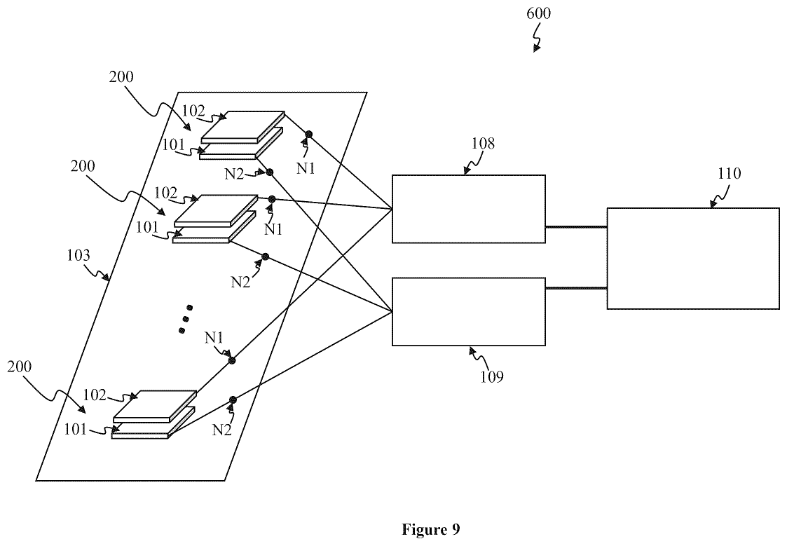

Optionally, the antenna system 500 may comprise one or more antenna devices 200 of FIG. 4. In this case, the description of FIG. 9 is correspondingly valid for the antenna system 500 of FIG. 8. For example, the one or more devices 200 may feed the calibration network 108 and may be fed from the feeding network 109 as described with regard to FIG. 9.

For further details on the antenna system of FIG. 8 reference is made to the description of the antenna system according to the fifth aspect of this disclosure and to the description of FIGS. 1 to 3 and 5.

FIG. 9 shows an example of an antenna system according to this disclosure. The antenna system 600 of FIG. 9 is an example of the antenna system according to the sixth aspect of this disclosure. The description of the antenna system according to the sixth aspect is correspondingly valid for the antenna system 600 of FIG. 9.

According to the example of FIG. 9, the antenna system 600 comprises three antenna devices 200 of FIG. 5. The number of antenna devices shown in FIG. 9 is only by way of example and, thus, the antenna system 600 may comprise one or more antenna devices 200 of FIG. 4. The following description is valid irrespective of the number of antenna devices of the antenna system 600. For a description of the one or more antenna devices 200 reference is made to the description of the antenna device of FIG. 4. Instead of each antenna device 200 comprising its own reflector, the antenna system 600 may comprise a common reflector 103 for all one or more antenna devices 200 of the antenna system 600. The description of a reflector of an antenna device herein is correspondingly valid for the common reflector 103. Alternatively, the one or more antenna devices 200 may each comprise a respective reflector 103 and the reflector(s) 103 of the one or more antenna devices 200 may form a reflector of the antenna system 600. In case the antenna system 600 comprises two or more antenna devices 100, the antenna devices 200 may form an antenna array according to FIG. 6.

The antenna system 600 may comprise a calibration network 108 configured to be fed from the node N1 of each of the one or more antenna devices 200. The calibration network 108 may be configured to use the energy, which is fed from the second radiating element 102 of the respective antenna device 100 via the node N1 of the respective antenna device 200 to the calibration network 108, to adjust the amplitude and/or the phase of the RF signal being fed to the first radiating element 101 of the respective antenna device 200.

Optionally, the antenna system 600 may comprise a feeding network 109 configured to feed a respective RF signal to the second node N2 of each antenna device 200 to transmit the respective RF signal in the form of radio waves. Thus, the feeding network 109 is configured to feed a RF signal via the second node N2 of each antenna device 200 to the first radiating element 101 of the respective antenna device 200. The antenna system 600 may optionally comprise a remote radio unit (RRU) 110 coupled, e.g. electrically connected, to the calibration network 108 and the feeding network 109. The RRU 110 may be configured to control the calibration network 108 and the feeding network 109. The RRU 110 may comprise or may be coupled, e.g. electrically connected, to a base band unit.

Optionally, the antenna system 600 may comprise one or more antenna devices 100 of FIG. 1. In this case, the description of FIG. 8 is correspondingly valid for the antenna system 600 of FIG. 9. For example, the one or more devices 100 may feed the calibration network 108 and may be fed from the feeding network 109 as described with regard to FIG. 8.

For further details on the antenna system of FIG. 9 reference is made to the description of the antenna system according to the sixth aspect of this disclosure and to the description of FIGS. 4 and 6.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. An antenna device, comprising:
a node for feeding a calibration network;
a first radiating element arranged in a first plane and configured to radiate a radio wave in response to a radio frequency signal being fed to the first radiating element; and
a second radiating element arranged in a second plane different to the first plane; wherein
the second radiating element is configured to radiate a radio wave in response to the RF signal being fed to the second radiating element, and
the antenna device comprises a distribution structure configured to:
feed the RF signal to the first radiating element and the second radiating element by providing an amplitude distribution of the RF signal between the first radiating element and the second radiating element; and
feed, via the node to the calibration network, at least a part of the energy of an electromagnetic coupling between the first radiating element and the second radiating element, when the RF signal is fed to the first radiating element and the second radiating element.

2. The antenna device according to claim 1, wherein
the distribution structure is configured to provide the RF signal with a phase shift between the first radiating element and the second radiating element when the RF signal is fed to the first radiating element and the second radiating element, or
the antenna device comprises a phase shifter arranged between the distribution structure and the first radiating element or the second radiating element, wherein the phase shifter is configured to provide the RF signal with a phase shift between the first radiating element and the second radiating element when the RF signal is fed to the first radiating element and the second radiating element.

3. The antenna device according to claim 1, wherein
the antenna device comprises the calibration network, and
the calibration network is configured to use energy, which is fed from the distribution structure via the node to the calibration network, to adjust the amplitude and/or the phase of the RF signal being fed to the first radiating element and the second radiating element.

4. The antenna device according to claim 1, wherein
the antenna device comprises a reflector arranged in a third plane different to the first plane and the second plane; and
the reflector is configured to reflect the radio waves radiated by the first radiating element and the second radiating element in response to the RF signal being fed to the first radiating element and second radiating element in a main radiating direction.

5. The antenna device according to claim 4, wherein
the first radiating element, the second radiating element, and the reflector are arranged on a common axis, and
the main radiating direction is away from the reflector along the common axis.

6. An antenna device, comprising:
a node configured to feed a calibration network;
a first radiating element arranged in a first plane and configured to radiate a radio wave in response to a radio frequency (RF) signal being fed to the first radiating element; and
a second radiating element arranged in a second plane different to the first plane, wherein
the second radiating element is configured to feed, via the node to the calibration network, at least a part of the energy of an electromagnetic coupling between the first radiating element and the second radiating element, when the RF signal is fed to the first radiating element.

7. The antenna device according to claim 6, wherein
the antenna device comprises the calibration network, and
the calibration network is configured to use energy, which is fed from the second radiating element via the node to the calibration network, to adjust the amplitude and/or the phase of the RF signal being fed to the first radiating element.

8. The antenna device according to claim 6, wherein
the antenna device comprises a reflector arranged in a third plane different to the first plane and second plane, and
the reflector is configured to reflect the radio wave radiated by the first radiating element in response to the RF signal being fed to the first radiating element in a main radiating direction.

9. The antenna device according to claim 8, wherein
the first radiating element the second radiating element, and the reflector are arranged on a common axis, and
the main radiating direction is away from the reflector along the common axis.

10. The antenna device according to claim 6, wherein
the first radiating element and the second radiating element are arranged on a common axis.

11. The antenna device according to claim 6, wherein
the first radiating element and the second radiating element are stacked to each other.

12. The antenna device according to claim 6, wherein
the first radiating element and the second radiating element each comprise a dipole.

13. An antenna array, comprising:
two or more antenna devices including a node for feeding a calibration network, a first radiating element arranged in a first plane and configured to radiate a radio wave in response to a radio frequency (RF) signal being fed to the first radiating element, and a second radiating element arranged in a second plane different to the first plane, wherein the second radiating element is configured to radiate a radio wave in response to the RF signal being fed to the second radiating element, and the antenna device comprises a distribution structure configured to feed the RF signal to the first radiating element and the second radiating element by providing an amplitude distribution of the RF signal between the first radiating element and the second radiating element, and feed, via the node to the calibration network, at least a part of the energy of an electromagnetic coupling between the first radiating element and the second radiating element, when the RF signal is fed to the first radiating element and the second radiating element, or
two or more antenna devices including a node configured to feed a calibration network, a first radiating element arranged in a first plane and configured to radiate a radio wave in response to the RF signal being fed to the first radiating element, and a second radiating element arranged in a second plane different to the first plane, wherein the second radiating element is configured to feed, via the node to the calibration network, at least a part of the energy of an electromagnetic coupling between the first radiating element and the second radiating element, when the RF signal is fed to the first radiating element.
